(19) United States
(12) Patent Application Publication
(10) Pub. No.: US 2013/0284317 A1
(43) Pub. Date: Oct. 31, 2013

(54) TIMBER PROCESSING WITH A KNUCKLEBOOM LOG LOADER

(71) Applicant: John Cudoc, Phillips, WI (US)

(72) Inventor: John Cudoc, Phillips, WI (US)

(73) Assignee: Caterpillar Forest Products Inc.

(21) Appl. No.: 13/459,415

(22) Filed: Apr. 30, 2012

(51) Int. Cl. A01G 23/00; A01G 23/095; B27B 31/00

(52) U.S. Cl. 144/343; 144/4.1; 144/335

(57) ABSTRACT

A machine for processing trees includes a trailer; a loader and a tree processing unit mounted on the trailer. The tree processing unit is configured to independently process loaded trees.

### TECHNICAL FIELD

This disclosure relates to timber processing equipment, and more particularly to timber processing with a knuckleboom log loader.

### BACKGROUND

Tree harvesting operations have often used a central processing area for processing timber. Given the nature of harvesting operations, it has been important to maintain some mobility and flexibility, even with equipment used in the central processing area.

One attempt to provide for efficient equipment in a central processing are is provided in U.S. Pat. No. 3,329,184, issued Jul. 4, 1967, and entitled “Apparatus for the Simultaneous Debranching and Debarking of Felled Trees and the Like.” This patent discloses a mobile apparatus that includes a work table. Disposed on the work table is a debranching and debarking apparatus. The debranching and debarking apparatus is relatively complicated, and involves at least one cutting chain for encircling the tree. A hydraulically actuated gripper pulls the tree along in the process until an appropriate length may be cut. Once the length is cut, the work table may require an incline adjustment, such that the wood pieces can then roll from the table. This apparatus results in a slow process, and includes substantially more equipment than an operator would want to maintain in the field. As one example, processing of each tree requires extending the hydraulically actuated gripper, engaging the tree, and pulling the tree forward. Half of the work performed by the hydraulically actuated gripper is wasted each time the gripper is extended. Further inefficiencies are inherent in this apparatus. As another example, frequent adjustment of inclination of the work table requires substantial supervision by an operator, thus impacting production and cost.

More recent central processing systems have made use of a combination system mounted on a trailer. For example, both a loader (e.g., a knuckleboom log loader) and a delimber are known to be mounted on a trailer. In operation, the loader loads the delimber with trees for delimbing. Generally, the delimber includes at least one set of clamps or cutting arms which are clamped around the tree. As the loader pulls the tree through the delimber, any limbs are broken or cut away. Very often, this trailer is accompanied by a nearby wood chipper as well as a nearby ground saw.

In operation, the loader is tasked with loading trees into the delimber. The loader is constantly engaged with each tree as the tree is fed through the delimber. Therefore, the loader is not free or available to engage in other functions when the trees are being delimbed. Accordingly, there is a cessation of delimbing operations when the loader is engaged in feeding the wood chipper with brush, as well as when the loader is attending to the cutting of delimbed trees to length with the ground saw.

### SUMMARY

In one exemplary embodiment, disclosed herein is a machine for processing trees that includes a trailer; a loader and a tree processing unit mounted on the trailer. The tree processing unit is configured to independently process loaded trees.

In another exemplary embodiment, disclosed herein is a method for processing trees. The method includes loading, via a loader, a tree into a tree processing unit; and independently processing, via the processing unit, the loaded tree.

In yet another exemplary embodiment, disclosed herein is a machine for processing trees. The machine includes a trailer including a loader and a tree processing unit mounted on the trailer. The tree processing unit is configured to independently process loaded trees thereby enabling the loader to perform other functions.

### BRIEF DESCRIPTION OF THE DRAWINGS

FIG. 1 is a side view of a timber processing station;

FIG. 2 is an isometric view of a tree processing unit suited for use in the timber processing station of FIG. 1;

FIG. 3 is a top schematic view of the timber processing station and a surrounding work area; and

FIG. 4 depicts aspects of an exemplary control system for the timber processing station.

### DETAILED DESCRIPTION

Disclosed herein is a timber processing station and method. The station includes a trailer having a loader mounted thereon and a tree processing unit mounted thereon. The tree processing unit is adapted for being loaded with a tree by the loader and for processing the tree into timber without aid from the loader.

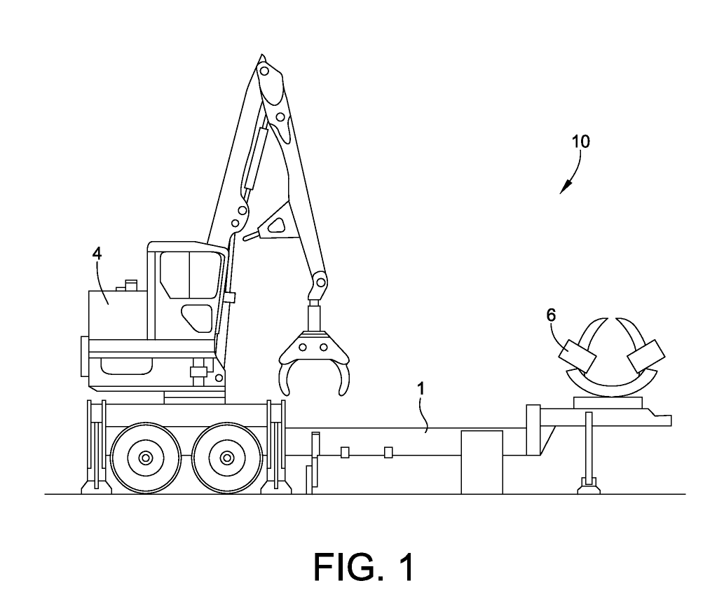

Refer to FIG. 1, where there is shown an embodiment of a timber processing machine 10. The timber processing machine 10 includes equipment mounted on a trailer 1. In some embodiments, the equipment is mounted onto a fixed platform. In this example, the equipment mounted on the trailer 1 includes a loader 4. In one example, the loader 4 can be a knuckleboom log loader. In some embodiments, the loader 4 is mounted on an end of the trailer 1 that is opposite to a tree processing unit 6. Accordingly, the loader 4 is afforded a range of movement that is not substantially impeded by the tree processing unit 6. In operation, the loader 4 is used to pick up trees from an area surrounding the loader 4 and to then load the trees into the tree processing unit 6. The tree processing unit 6 will then process each loaded tree into timber.

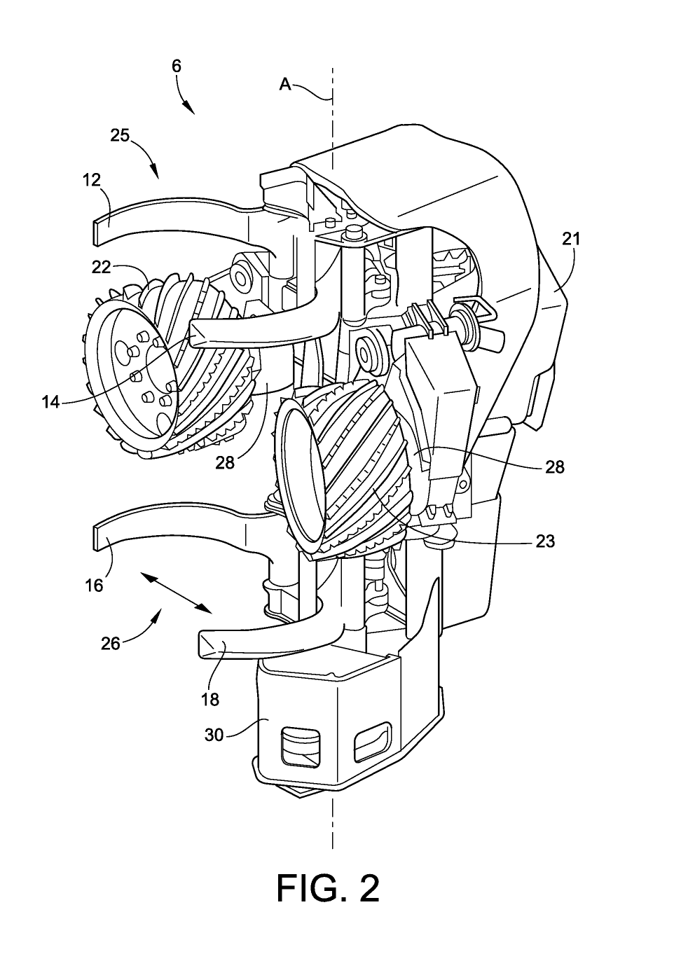

Referring to FIG. 2, where the tree processing unit 6 is shown. The exemplary tree processing unit 6 includes a mounting member 21 suited for mounting the tree processing unit 6 to the trailer 1. Generally, the tree processing unit 6 is mounted to the trailer 1 so that a longitudinal axis, A, of the tree processing unit 6 is parallel to a top surface of the trailer 1, and in an orientation that facilitates feeding of the tree processing unit 6 by the loader 4.

The exemplary tree processing unit 6 may include one or more wheels (e.g., feed rollers 22 and 23) configured to receive and engage a portion of a tree and feed the portion of the tree in the direction of the longitudinal axis, A, into the tree processing unit 6. Exemplary feed rollers 22 and 23 may each include a motor 28 operably coupled to feed rollers 22 and 23. In some embodiments, the motor 28 is one of a hydraulic motor, an electric motor and an internal combustion engine. Generally, the motor 28 is configured to drive feed rollers 22 and 23, and therefore includes apparatus as appropriate (e.g., a drive shaft and/or a transmission). Generally, the feed rollers 22, 23 are adapted for frictional engagement of the tree, such as with a series of gripping features (as depicted). At least one of the feed rollers 22, 23 may translate such that pressure is applied to the tree, and thus the tree is fed through the tree processing unit 6 as the feed rollers 22, 23 engage the tree.

The tree processing unit 6 may also include at least one cutting device such as, for example, cutting devices 25 and 26. According to some embodiments, cutting device 25 includes a pair of delimbing (or debarking) knives 12 and 14 configured to remove bark and/or limbs from a trunk of the tree as the tree is fed through the tree processing unit 6. Similarly, cutting device 26 may include a pair of delimbing (or debarking) knives 16 and 18 configured to remove bark and/or limbs from a tree trunk as it is fed through tree processing unit 6. In operation, in some embodiments, at least one of cutting device 25 and cutting device 26 engage a tree by clamping together. For example, at least one of knives 16 and 18 is rotated toward the opposing knife as the tree is feed into the tree processing unit 6, thus surrounding a girth of the tree.

In some embodiments, when at least one of cutting device 25 and 26 is engaged (i.e., clamped about the tree), an entire circumference of the tree is presented with at least one cutting surface, such as cutting knife 16, 18. Accordingly, at least one of cutting device 25 and 26 ensures complete delimbing of the tree (i.e., delimbing about the entire circumference of the tree).

In some embodiments, at least one of cutting device 25 and 26 may be powered by at least one hydraulic actuator (not shown).

According to some embodiments, tree processing unit 6 may include an additional cutting device 30. For example, tree processing unit 6 shown in FIG. 2 includes cutting device 30, which may be in the form of a saw, a blade, and/or a knife. The cutting device 30 may be configured to cut a tree into a number of sections as the tree passes through tree processing unit 6.

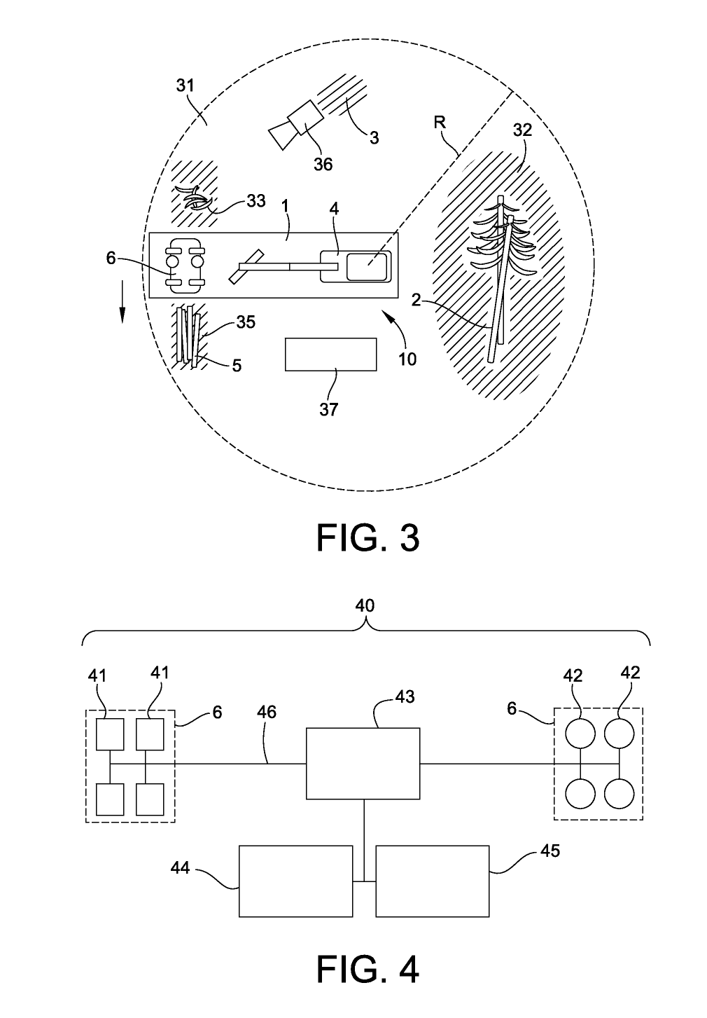

Referring now to FIG. 3, there is shown an exemplary work area 31 for the timber processing machine 10. Generally, the work area 31 is a circular area defined by a radius, R. The radius, R, is defined by a reach of the loader 4. Included in the work area 31, in this example, is a laydown area 32, where operators deposit trees 2 (i.e., timber) for processing. Once trees 2 are deposited in the work area 32, the loader 4 can be used to pick up each tree 2, and to load the tree 2 into the tree processing unit 6. As the tree 2 is processed in the tree processing unit 6, a brush pile 33 may be created. That is, limbs that result from delimbing of each tree 2 are rejected by the tree processing unit 6 into the brush pile 33. As each of the trees 2 are processed by the tree processing unit 6, a log pile 35 that includes processed timber 5 is realized.

As the tree processing unit 6 is equipped to delimb and cut each tree 2 into appropriate length(s) without assistance of the loader, the loader 4 is available for other tasks. For example, the loader 4 may load chipper 36 with brush from the brush pile 33, thus resulting in a pile of wood chips 3. In addition, the loader 4 may be used to further cut down processed timber 5 using optional ground saw 37, or may be used to load a transport vehicle (not shown).

Referring to FIG. 4, in some embodiments, the tree processing unit 6 can be controlled with a control system 40. For example, tree processing unit 6 may be equipped with at least one sensor 41, such as an electrical, mechanical or optical sensor 41. The sensor 41 may be used for, among other things, sensing or estimating a position of the tree 2. The at least one sensor 41 may provide feedback to a control unit 43 for controlling the tree processing unit 6. The at least one sensor 41 may include apparatus for measuring length, weight, position, girth, processing speed, temperature and the like. The at least one sensor 41 may be configured to monitor any condition, parameter or other aspect that can be useful for controlling production.

The control unit 43 may include conventional control apparatus. For example, the control unit 43 may include at least one processor, memory, data storage, a clock, and the like. The control unit 43 may also include machine executable media that include machine executable instructions stored therein, the instructions for at least one of operating and controlling the tree processing unit 6. For example, the control unit 43 may include instructions for at least one of receiving feedback, determining a control instruction, providing a control instruction, storing processing information and communicating processing information.

The control unit 43 may be supplied power from a power supply 44, which may include any source of power deemed appropriate.

The control unit 43 may be used to control the tree processing unit 6 according to desired criteria. Accordingly, controls 42 such as valves, actuators, servos, motors, may be controlled by a control instruction issued by the control unit 43. Thus, the control system 40 includes at least one communications link 46 to ensure sensing information and control information is properly communicated.

For example, the control unit 43 may sense loading of the tree 2 with a loading sensor 41. The control unit 43 may then engage the tree 2 controlling the tree processing unit 6 to cause clamping down of at least one of feed roller 22, 23, and cutting device(s) 25, 26. The control unit 43 may then sense a length of processed tree 2 by another sensor 41, or, for example, by steps of the motor 28, thus mechanically estimating a position of the tree. When the control unit 43 determines an appropriate length of the tree 2 has been processed, the control unit 43 will actuate cutting device 30 and processed timber 5 will be ejected into the log pile 35. The tree 2 may be cut into portions of equal length or portions of unequal length, depending on, for example, the needs of an operator.

It is contemplated that control unit 43 may be operated manually (e.g., with real-time operator input) and/or automatically (e.g., without real-time operator input).

According to some embodiments, control unit 43 may be disposed within the tree processing unit 6 (e.g., it may be incorporated into tree processing unit 6, as for example, an on-board control module, not shown).

In some embodiments, the control system 40 may include at least one interface 45, such as a remotely located interface 45 (e.g., in a cab of the loader 4). In these latter embodiments, the control system 40 generally includes at least one user interface (not shown). A combination of a local interface and a remote interface may be configured in control system 40. Embodiments of the user interface may include mechanical and electronic controls, as well as computer interface equipment, such as at least one of a USB, parallel and serial port.

The control system 40 may be equipped to monitor production of the tree processing unit 6. For example, the control system 40 may provide users with information regarding hours of operation, footage processed, weight processed, maintenance information and the like.

### INDUSTRIAL APPLICABILITY

Maximizing throughput in a central processing area has traditionally involved addition of a secondary loader. Generally, the secondary loader is used to attend to loading of brush as well as feeding the ground saw. The timber processing machine 10 provides an efficient system for processing trees.

Having discussed aspects of the timber processing machine 10 and the tree processing unit 6, it should be recognized that the teachings herein greatly increase production when compared with conventional centralized timber processing equipment.

More specifically, the timber processing machine 10 that is equipped according to the teachings herein enhances an ability of operators to make efficient use of other equipment. For example, with the timber processing machine 10 disclosed herein, the loader 4 is now available to efficiently load brush into a nearby chipper while retrieving trees for processing. The loader 4 is now available to load the brush, collect and stack processed timber and perform other tasks while processing of other trees is ongoing.

As a further example of efficiencies realized, in some embodiments, placement of the chipper 36 affords users opportunities to increase work performed by the loader 4. More specifically, and with reference to FIG. 3, in some embodiments, the loader 4 may travel in one direction (e.g., counter-clockwise) with a tree for loading into the tree processing unit 6. Once the tree is loaded, the loader 4 may pick up brush from the brush pile 33 which is located at the loading area of the tree processing unit 6. The loader 4 can then rotate in a reverse (i.e., clockwise) direction and stops to load the chipper 36. Thus, chipping operations may be effectively integrated into loading operations.

Thus, the integrated setup of the loader 4 and tree processing unit 6 allows a single loader 4 to supply two wood streams (i.e., the processing unit 6, as well as the chipper 36) in one operation cycle.

Further, when making use of the control system 40, users are provided with insight into timber processing operations, thereby permitting improved accounting and production.

What is claimed is:

1. A machine for processing trees comprising:
a trailer;
a loader and a tree processing unit mounted on the trailer, wherein the tree processing unit is configured to independently process loaded trees.

2. The machine of claim 1, wherein the loader is a knuckleboom log loader.

3. The machine of claim 1, wherein the tree processing unit includes at least one feed roller adapted to roll the tree to desired positions for processing.

4. The machine of claim 1, wherein the tree processing unit includes at least one set of delimbing knives.

5. The machine of claim 1, wherein the tree processing unit includes at least one set of delimbing knives that surround the tree when the knife is engaged.

6. The machine of claim 1, wherein the tree processing unit includes at least one cutting device for segmenting the tree.

7. The machine of claim 1, further comprising: a control unit in operative communication with the tree processing unit, the control unit configured to determine signals indicative of operations of the tree processing unit and to control operations of the tree processing unit based on the determined signals.

8. The machine of claim 7, wherein the control unit comprises at least one of a local interface and a remote interface.

9. A method for processing trees comprising:
loading, via a loader, a tree into a tree processing unit; and
independently processing the loaded tree via the tree processing unit.

10. The method of claim 9, wherein the tree processing unit is configured with at least one saw for cutting the tree at a desired length.

11. The method of claim 9, wherein the tree processing unit is configured with at least one delimber knife adapted for delimbing branches and brushes of the tree.

12. The method of claim 9, wherein the tree processing unit includes at least one feed roller adapted to roll the tree into desired positions for processing.

13. The method of claim 9, further comprising: determining signals indicative of operations of the tree processing unit; and
controlling operations of the tree processing unit based on the determined signals.

14. The method of claim 13, wherein the controlled operations are performed via at least one of a remote interface and a local interface.

15. A machine for processing trees comprising:
a trailer including a loader and a tree processing unit mounted on the trailer, wherein the tree processing unit is configured to independently process loaded trees thereby enabling the loader to perform other functions.

16. The machine of claim 15, wherein the tree processing unit further comprises at least one cutting device for cutting the tree.

17. The machine of claim 15, wherein the tree processing unit includes at least one delimbing knife configured to substantially surround the tree.

18. The machine of claim 15, further comprising a control system to control processing.

19. The machine of claim 15, wherein the tree processing unit includes a motor operably coupled to at least one feed roller.

20. The machine of claim 15, wherein the tree processing unit includes at least one delimbing knife powered by a hydraulic actuator.
